(19) United States
(12) Patent Application Publication
(10) Pub. No.: US 2014/0140315 A1
(43) Pub. Date: May 22, 2014

(54) METHOD FOR ADJUSTING UPLINK TRANSMISSION TIMING IN BASE STATION COOPERATIVE WIRELESS COMMUNICATION SYSTEM AND APPARATUS FOR SAME

(71) Applicants: Hakseong Kim, Anyang-si (KR); Hanbyul Seo, Anyang-si (KR)

(72) Inventors: Hakseong Kim, Anyang-si (KR); Hanbyul Seo, Anyang-si (KR)

(73) Assignee: LG ELECTRONICS INC., Seoul (KR)

(21) Appl. No.: 14/234,102

(22) PCT Filed: Aug. 6, 2012
(86) PCT No.: PCT/KR2012/006234

§ 371 Date: Jan. 21, 2014

Related U.S. Application Data
(60) Provisional application No. 61/524,306, filed on Aug. 16, 2011.

(51) Int. Cl. H04W 72/12; H04W 88/02

(52) U.S. Cl. CPC H04W 72/1268; H04W 88/02
USPC 370/329

(57) ABSTRACT

In the present invention, a method for transmitting an uplink signal to a plurality of base stations at a user equipment in a wireless communication system is disclosed. More particularly, the method comprises the steps of receiving, from a serving base station, uplink timing information corresponding to each of the plurality of base stations; and transmitting the uplink signal to each of the plurality of base stations in a unit of subframe according to the uplink timing information, wherein, if a transmission timing of a first subframe to a first base station of the plurality of base stations is overlapped with a transmission timing of a second subframe to a second base station that follows the first subframe, at least one symbol of the first subframe overlapping with the second subframe is not transmitted.

### TECHNICAL FIELD

The present invention relates to a wireless communication system, and more particularly, to a method for adjusting uplink transmission timing in a base station cooperative wireless communication system and an apparatus for the same.

### BACKGROUND ART

A 3^{rd} generation partnership project long term evolution (3GPP LTE) (hereinafter, referred to as ‘LTE’) communication system which is an example of a wireless communication system to which the present invention can be applied will be described in brief.

FIG. 1 is a diagram illustrating a network structure of an Evolved Universal Mobile Telecommunications System (E-UMTS) which is an example of a mobile communication system. The E-UMTS is an evolved version of the conventional UMTS, and its basic standardization is in progress under the 3rd Generation Partnership Project (3GPP). The E-UMTS may also be referred to as a Long Term Evolution (LTE) system. For details of the technical specifications of the UMTS and E-UMTS, refer to Release 7 and Release 8 of “3rd Generation Partnership Project; Technical Specification Group Radio Access Network”.

Referring to FIG. 1, the E-UMTS includes a User Equipment (UE), a base station (eNode B; eNB), and an Access Gateway (AG) which is located at an end of a network (E-UTRAN) and connected to an external network. Generally, the base station may simultaneously transmit multiple data streams for a broadcast service, a multicast service and/or a unicast service.

One or more cells may exist for one base station. One cell is set to one of bandwidths of 1.25, 2.5, 5, 10, and 20 MHz to provide a downlink or uplink transport service to several user equipments. Different cells may be set to provide different bandwidths. Also, the base station controls data transmission and reception for a plurality of user equipments. The base station transmits downlink (DL) scheduling information of downlink data to the corresponding user equipment to notify the corresponding user equipment of time and frequency domains to which data will be transmitted and information related to encoding, data size, and hybrid automatic repeat and request (HARQ). Also, the base station transmits uplink (UL) scheduling information of uplink data to the corresponding user equipment to notify the corresponding user equipment of time and frequency domains that can be used by the corresponding user equipment, and information related to encoding, data size, and HARQ. An interface for transmitting user traffic or control traffic can be used between the base stations. An interface for transmitting user traffic or control traffic may be used between the base stations. A Core Network (CN) may include the AG and a network node or the like for user registration of the user equipment UE. The AG manages mobility of the user equipment UE on a Tracking Area (TA) basis, wherein one TA includes a plurality of cells.

Although the wireless communication technology developed based on WCDMA has been evolved into LTE, request and expectation of users and providers have continued to increase. Also, since another wireless access technology is being continuously developed, new evolution of the wireless communication technology will be required for competitiveness in the future. In this respect, reduction of cost per bit, increase of available service, use of adaptable frequency band, simple structure, open type interface, proper power consumption of the user equipment, etc. are required.

### DISCLOSURE

### Technical Problem

Based on aforementioned discussion, an object of the present invention devised to solve the conventional problem is to provide a method for adjusting uplink transmission timing in a base station cooperative wireless communication system and an apparatus for the same.

### Technical Solution

In one aspect of the present invention, a method for transmitting an uplink signal to a plurality of base stations at a user equipment in a wireless communication system, the method comprises the steps of receiving, from a serving base station, uplink timing information corresponding to each of the plurality of base stations; and transmitting the uplink signal to each of the plurality of base stations in a unit of subframe according to the uplink timing information, wherein, if a transmission timing of a first subframe to a first base station of the plurality of base stations is overlapped with a transmission timing of a second subframe to a second base station that follows the first subframe, at least one symbol of the first subframe overlapping with the second subframe is not transmitted.

Preferably, rate matching or puncturing is performed for the other symbols except for the at least one symbol of the first subframe if the uplink signal transmitted to the first base station is a data signal.

More preferably, a control signal is generated as an uplink control information format having a size of the other symbols except for the at least one symbol in the first subframe if the uplink signal transmitted to the first base station is the control signal.

Moreover, the step of transmitting the uplink signal comprises transmitting the uplink signal prior to a reference timing according to the uplink timing information, and the uplink timing information is changed due to the difference of a distance between the user equipment and each of the plurality of base stations.

Also, a sounding reference signal scheduled to be transmitted in the first subframe is delayed to one of subframes after the first subframe, or is dropped.

In another aspect of the present invention, a user equipment in a wireless communication system comprises a wireless communication module configured to communicate a signal with a plurality of base stations; and a processor configured to process the signal, wherein the wireless communication module receives uplink timing information corresponding to each of the plurality of base stations from a serving base station, wherein the processor controls the wireless communication module to transmit an uplink signal to each of the plurality of base stations in a unit of subframe according to the uplink timing information, and wherein, if a transmission timing of a first subframe to a first base station of the plurality of base stations is overlapped with a transmission timing of a second subframe to a second base station that follows the first subframe, the processor controls the wireless communication module not to transmit at least one symbol of the first subframe overlapping with the second subframe.

Preferably, the processor performs rate matching or puncturing for the other symbols except for the at least one symbol included in the first subframe if the uplink signal transmitted to the first base station is a data signal.

More preferably, the processor generates a control signal as an uplink control information format having a size of the other symbols except for the at least one symbol in the first subframe if the uplink signal transmitted to the first base station is the control signal.

### Advantageous Effects

According to the embodiments of the present invention, the user equipment may effectively adjust uplink transmission timing in a base station cooperative wireless communication system.

It will be appreciated by persons skilled in the art that that the effects that could be achieved with the present invention are not limited to what has been particularly described hereinabove and other advantages of the present invention will be more clearly understood from the following detailed description.

### BRIEF DESCRIPTION OF THE DRAWINGS

FIG. 1 is a diagram illustrating a network structure of an Evolved Universal Mobile Telecommunications System (E-UMTS), which is an example of a wireless communication system;

FIG. 2 is a diagram illustrating structures of a control plane and a user plane of a radio interface protocol between a user equipment and an E-UTRAN based on the 3GPP radio access network standard;

FIG. 3 is a diagram illustrating physical channels used in a 3GPP system and a general method for transmitting a signal using the physical channels;

FIG. 4 is a diagram illustrating a structure of a radio frame used in an LTE system;

FIG. 5 is a diagram illustrating a structure of a downlink radio frame used in an LTE system;

FIG. 6 is a conceptional diagram illustrating a carrier aggregation scheme;

FIG. 7 is a diagram illustrating an application example of a cross carrier scheduling scheme;

FIG. 8 is a diagram illustrating a configuration of a heterogeneous network to which CoMP scheme may be applied;

FIG. 9 is a diagram illustrating a wireless communication system to which an uplink CoMP scheme according to the present invention is applied;

FIGS. 10 and 11 are diagrams illustrating an example of timing advance varied by the difference in a distance between two reception points;

FIGS. 12 and 13 are diagrams illustrating an example of timing advance varied by the difference in a distance among three reception points when CoMP uplink transmission is performed for the three reception points; and

FIG. 14 is a block diagram illustrating a communication apparatus according to one embodiment of the present invention.

### BEST MODE FOR CARRYING OUT THE INVENTION

Hereinafter, structures, operations, and other features of the present invention will be understood readily by the preferred embodiments of the present invention, examples of which are illustrated in the accompanying drawings. Embodiments described later are examples in which technical features of the present invention are applied to 3GPP system.

Although the embodiment of the present invention will be described based on the LTE system and the LTE-A system in this specification, the LTE system and the LTE-A system are only exemplary, and the embodiment of the present invention may be applied to all communication systems corresponding to the aforementioned definition.

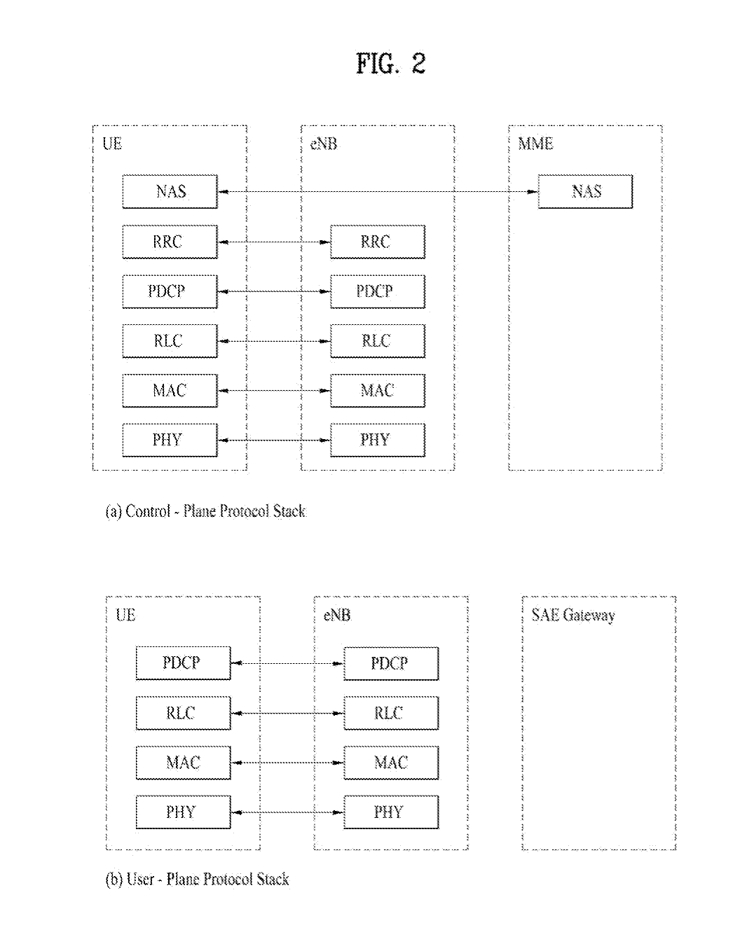

FIG. 2 is a diagram illustrating structures of a control plane and a user plane of a radio interface protocol between a user equipment and E-UTRAN based on the 3GPP radio access network standard. The control plane means a passageway where control messages are transmitted, wherein the control messages are used by the user equipment and the network to manage call. The user plane means a passageway where data generated in an application layer, for example, voice data or Internet packet data are transmitted.

A physical layer as the first layer provides an information transfer service to an upper layer using a physical channel. The physical layer is connected to a medium access control (MAC) layer via a transport channel, wherein the medium access control layer is located above the physical layer. Data are transferred between the medium access control layer and the physical layer via the transport channel. Data are transferred between one physical layer of a transmitting side and the other physical layer of a receiving side via the physical channel. The physical channel uses time and frequency as radio resources. In more detail, the physical channel is modulated in accordance with an orthogonal frequency division multiple access (OFDMA) scheme on a downlink, and is modulated in accordance with a single carrier frequency division multiple access (SC-FDMA) scheme on an uplink.

A medium access control (MAC) layer of the second layer provides a service to a radio link control (RLC) layer above the MAC layer via a logical channel. The RLC layer of the second layer supports reliable data transmission. The RLC layer may be implemented as a functional block inside the MAC layer. In order to effectively transmit data using IP packets such as IPv4 or IPv6 within a radio interface having a narrow bandwidth, a packet data convergence protocol (PDCP) layer of the second layer performs header compression to reduce the size of unnecessary control information.

A radio resource control (RRC) layer located on the lowest part of the third layer is defined in the control plane only. The RRC layer is associated with configuration, re-configuration and release of radio bearers (‘RBs’) to be in charge of controlling the logical, transport and physical channels. In this case, the RB means a service provided by the second layer for the data transfer between the user equipment and the network. To this end, the RRC layers of the user equipment and the network exchange RRC message with each other. If the RRC layer of the user equipment is RRC connected with the RRC layer of the network, the user equipment is in an RRC connected mode. If not so, the user equipment is in an RRC idle mode. A non-access stratum (NAS) layer located above the RRC layer performs functions such as session management and mobility management.

One cell constituting a base station eNB is set to one of bandwidths of 1.25, 2.5, 5, 10, 15, and 20 Mhz and provides a downlink or uplink transmission service to several user equipments. At this time, different cells may be set to provide different bandwidths.

As downlink transport channels carrying data from the network to the user equipment, there are provided a broadcast channel (BCH) carrying system information, a paging channel (PCH) carrying paging message, and a downlink shared channel (SCH) carrying user traffic or control messages. Traffic or control messages of a downlink multicast or broadcast service may be transmitted via the downlink SCH or an additional downlink multicast channel (MCH). Meanwhile, as uplink transport channels carrying data from the user equipment to the network, there are provided a random access channel (RACH) carrying an initial control message and an uplink shared channel (UL-SCH) carrying user traffic or control message. As logical channels located above the transport channels and mapped with the transport channels, there are provided a broadcast control channel (BCCH), a paging control channel (PCCH), a common control channel (CCCH), a multicast control channel (MCCH), and a multicast traffic channel (MTCH).

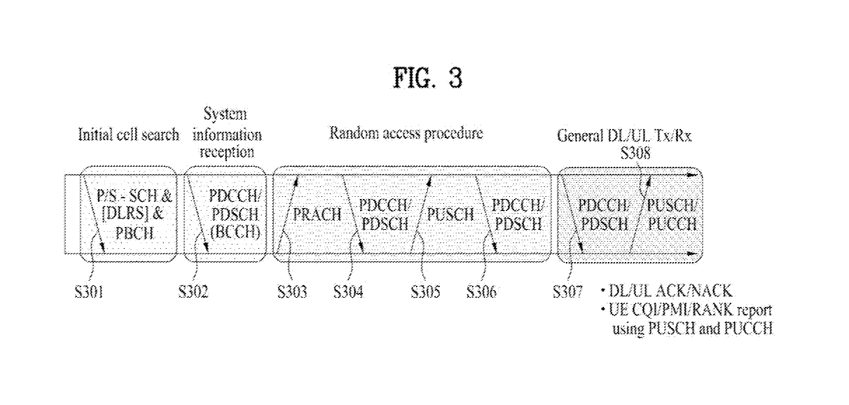

FIG. 3 is a diagram illustrating physical channels used in a 3GPP system and a general method for transmitting a signal using the physical channels.

The user equipment performs initial cell search such as synchronizing with the base station when it newly enters a cell or the power is turned on (S301). To this end, the user equipment may synchronize with the base station by receiving a primary synchronization channel (P-SCH) and a secondary synchronization channel (S-SCH) from the base station, and may acquire information of cell ID, etc. Afterwards, the user equipment may acquire broadcast information within the cell by receiving a physical broadcast channel (PBCH) from the base station. In the mean time, the user equipment may identify the status of a downlink channel by receiving a downlink reference signal (DL RS) at the initial cell search step.

The user equipment which has finished the initial cell search may acquire more detailed system information by receiving a physical downlink shared channel (PDSCH) in accordance with a physical downlink control channel (PDCCH) and information carried in the PDCCH (S302).

In the meantime, if the user equipment initially accesses the base station, or if there is no radio resource for signal transmission, the user equipment may perform a random access procedure (RACH) for the base station (S303 to S306). To this end, the user equipment may transmit a preamble of a specific sequence through a physical random access channel (PRACH) (303 and S305), and may receive a response message to the preamble through the PDCCH and the PDSCH corresponding to the PDCCH (S304 and S306). In case of a contention based RACH, a contention resolution procedure may be performed additionally.

The user equipment which has performed the aforementioned steps may receive the PDCCH/PDSCH (S307) and transmit a physical uplink shared channel (PUSCH) and a physical uplink control channel (PUCCH) (S308), as a general procedure of transmitting uplink/downlink signals. In particular, the user equipment receives downlink control information (DCI) through the PDCCH. In this case, the DCI includes control information such as resource allocation information on the user equipment, and has different formats depending on its usage.

In the meantime, the control information transmitted from the user equipment to the base station or received from the base station to the user equipment through the uplink includes downlink/uplink ACK/NACK signals, a channel quality indicator (CQI), a precoding matrix index (PMI), a scheduling request (SR), and a rank indicator (RI). In case of the 3GPP LTE system, the user equipment may transmit the aforementioned control information such as CQI/PMI/RI through the PUSCH and/or the PUCCH.

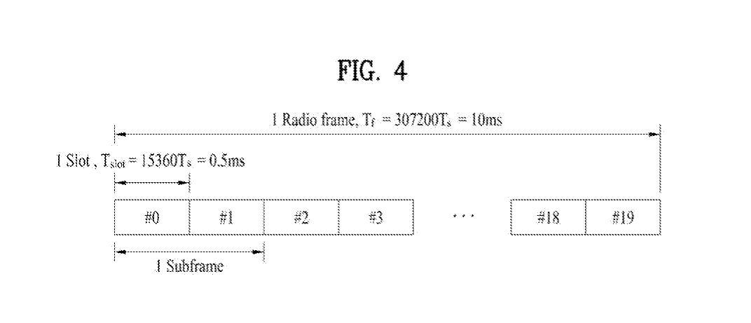

FIG. 4 is a diagram illustrating a structure of a radio frame used in an LTE system.

Referring to FIG. 4, a radio frame has a length of 10 ms (327200×Tₛ) and includes ten (10) subframes of an equal size. Each sub frame has a length of 1 ms and includes two slots. Each slot has a length of 0.5 ms (15360Tₛ). In this case, Tₛ represents a sampling time, and is expressed by Tₛ=1/(15 kHz×2048)=3.2552×10⁻⁸ (about 33 ns). The slot includes a plurality of orthogonal frequency division multiplexing (OFDM) symbols or single carrier-frequency division multiple access (SC-FDMA) symbols in a time domain, and includes a plurality of resource blocks (RBs) in a frequency domain. In the LTE system, one resource block includes twelve (12) subcarriers×seven (or six) OFDM symbols or SC-FDMA symbols. A transmission time interval (TTI), which is a transmission unit time of data, may be determined in a unit of one or more subframes. The aforementioned structure of the radio frame is only exemplary, and various modifications may be made in the number of subframes included in the radio frame or the number of slots included in the subframe, or the number of OFDM symbols or SC-FDMA symbols included in the slot.

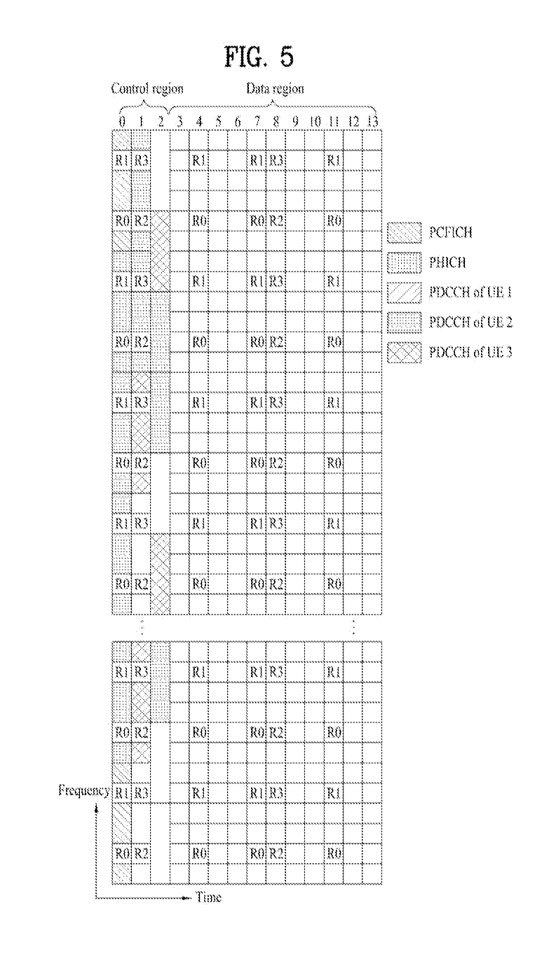

FIG. 5 is a diagram illustrating a control channel included in a control region of one subframe in a downlink radio frame.

Referring to FIG. 5, the subframe includes fourteen (14) OFDM symbols. First one to three OFDM symbols are used as the control region in accordance with subframe configuration, and the other thirteen to eleven OFDM symbols are used as the data region. In FIG. 5, R1 to R4 represent reference signals (RS) (or pilot signals) of antennas 0 to 3. The RS is fixed by a given pattern within the subframe regardless of the control region and the data region. The control channel is allocated to a resource to which the RS is not allocated in the control region, and a traffic channel is also allocated to a resource to which the RS is not allocated in the data region. Examples of the control channel allocated to the control region include a Physical Control Format Indicator Channel (PCFICH), a Physical Hybrid-ARQ Indicator Channel (PHICH), and a Physical Downlink Control Channel (PDCCH).

The PCFICH notifies the user equipment of the number of OFDM symbols used in the PDCCH per subframe. The PCFICH is located in the first OFDM symbol and configured prior to the PHICH and the PDCCH. The PCFICH includes four resource element groups (REG), each REG being distributed in the control region based on cell identity (cell ID). One REG includes four resource elements (REs). The RE represents a minimum physical resource defined by one subcarrier×one OFDM symbol. The PCFICH value indicates a value of 1 to 3 or a value of 2 to 4 depending on a bandwidth, and is modulated by Quadrature Phase Shift Keying (QPSK).

The PHICH is a physical hybrid-automatic repeat and request (HARQ) indicator channel and is used to carry HARQ ACK/NACK signals for uplink transmission. Namely, the PHICH represents a channel where DL ACK/NACK information for UL HARQ is transmitted. The PHICH includes one REG, and is cell-specifically scrambled. The ACK/NACK signals are indicated by 1 bit, and are modulated by binary phase shift keying (BPSK). The modulated ACK/NACK are spread by a spreading factor (SF)=2 or 4. A plurality of PHICHs may be mapped with the same resource and constitute a PHICH group. The number of PHICHs multiplexed in the PHICH group is determined by the number of spreading codes. The PHICH (group) is repeated three times to obtain diversity gain in the frequency domain and/or the time domain.

The PDCCH is allocated to first n number of OFDM symbols of the subframe, wherein n is an integer greater than 1 and is indicated by the PCIFCH. The PDCCH includes one or more CCEs. The PDCCH notifies each user equipment or user equipment group of information related to resource allocation of transport channels, i.e., a paging channel (PCH) and a downlink-shared channel (DL-SCH), uplink scheduling grant, HARQ information, etc. The paging channel (PCH) and the downlink-shared channel (DL-SCH) are transmitted through the PDSCH. Accordingly, the base station and the user equipment respectively transmit and receive data through the PDSCH except for specific control information or specific service data.

Information as to user equipment(s) (one user equipment or a plurality of user equipments) to which data of the PDSCH are transmitted, and information as to how the user equipment(s) receives and decodes PDSCH data are transmitted by being included in the PDCCH. For example, it is assumed that a specific PDCCH is CRC masked with radio network temporary identity (RNTI) called “A,” and information of data transmitted using a radio resource (for example, frequency location) called “B” and transmission format information (for example, transport block size, modulation mode, coding information, etc.) called “C” is transmitted through a specific subframe. In this case, one or more user equipments located in a corresponding cell monitor the PDCCH by using their RNTI information, and if there are one or more user equipments having RNTI called “A”, the user equipments receive the PDCCH, and receive the PDSCH indicated by “B” and “C” through information of the received PDCCH.

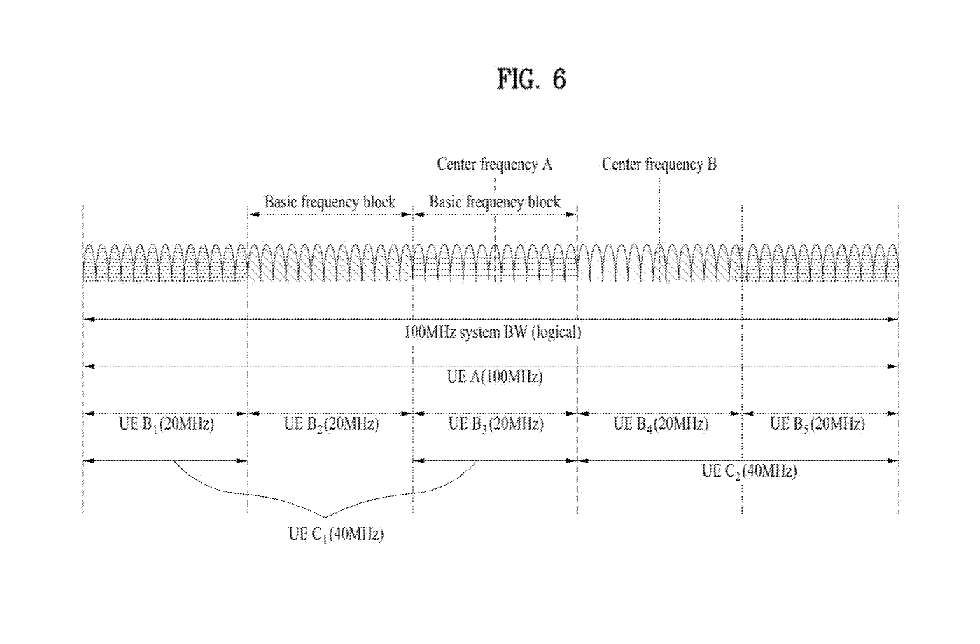

Hereinafter, a carrier aggregation scheme will be described. FIG. 6 is a conceptional diagram illustrating a carrier aggregation scheme.

The carrier aggregation means that the user equipment uses a plurality of frequency blocks or (logical) cells, which include uplink resources (or component carriers) and/or downlink resources (or component carriers), as one large logical frequency band to enable a wireless communication system to use a wider frequency band. Hereinafter, for convenience of description, the carrier aggregation will be referred to as component carriers.

Referring to FIG. 6, a whole system bandwidth (system BW) is a logical band and has a bandwidth of 100 MHz. The whole system bandwidth includes five component carriers, each of which has a bandwidth of maximum 20 MHz. The component carrier includes at least one or more physically continuous subcarriers. Although the respective component carriers have the same bandwidth in FIG. 6, it is only exemplary, and the component carriers may have their respective bandwidths different from one another. Also, although the respective component carriers adjoin each other in the frequency domain as shown, the drawing just represents the logical concept. The respective component carriers may logically adjoin each other, or may be spaced apart from each other.

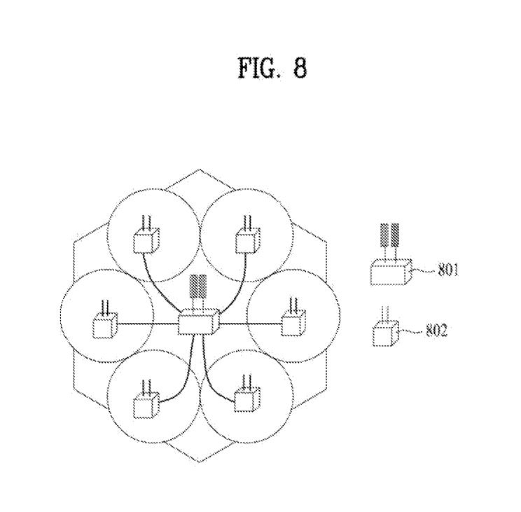

A center frequency may be used differently for each of the component carriers. Alternatively, one center carrier common for physically adjoining component carriers may be used. For example, assuming that all component carriers are physically adjacent to one another in FIG. 8, a center carrier ‘A’ may be used. Also, assuming a case that the respective component carriers are not physically adjacent to each other, a center carrier ‘A’ and a center carrier ‘B’ may be used separately from the respective component carriers.

In this specification, a component carrier may correspond to a system bandwidth of a legacy system. By defining a component carrier based on a legacy system, it is possible to facilitate provision of backward compatibility and system design in a wireless communication environment in which an evolved user equipment and a legacy user equipment coexist. For example, in case that the LTE-A system supports carrier aggregation, each component carrier may correspond to a system bandwidth of the LTE system. In this case, the component carrier may have a bandwidth selected from the group including 1.25 MHz, 2.5 MHz, 5 MHz, 10 MHz and 20 MHz.

In case that a whole system band is extended by carrier aggregation, a frequency band used for communication with each user equipment is defined by a component carrier unit. A user equipment A may use a whole system bandwidth of 100 MHz and performs communication using five component carriers all. User equipments B₁ to B₅ may use a bandwidth of 20 MHz only, and each of the user equipments B₁ to B₅ performs communication using one component carrier. User equipment C₁ and user equipment C₂ may use a bandwidth of 40 MHz. Each of the user equipment C₁ and the user equipment C₂ performs communication using two component carriers. In this case, these two component carriers may be logically/physically adjacent to each other or may not. The user equipment C₁ represents a case of using two component carriers that are not adjacent to each other, and the user equipment C₂ represents a case that two adjacent component carriers are used.

One downlink component carrier and one uplink component carrier are used in the LTE system, whereas several component carriers may be used in the LTE-A system as shown in FIG. 6. At this time, a scheme of scheduling a data channel through a control channel may be divided into a linked carrier scheduling scheme of the related art and a cross carrier scheduling scheme.

In more detail, according to the linked carrier scheduling scheme, like the existing LTE system that uses a single component carrier, a control channel transmitted through a specific component carrier performs scheduling for a data channel only through the specific component carrier.

In the meantime, according to the cross carrier scheduling scheme, a control channel transmitted through a primary component carrier (CC) using a carrier indicator field (CIF) performs scheduling for a data channel transmitted through the primary component carrier or another component carrier.

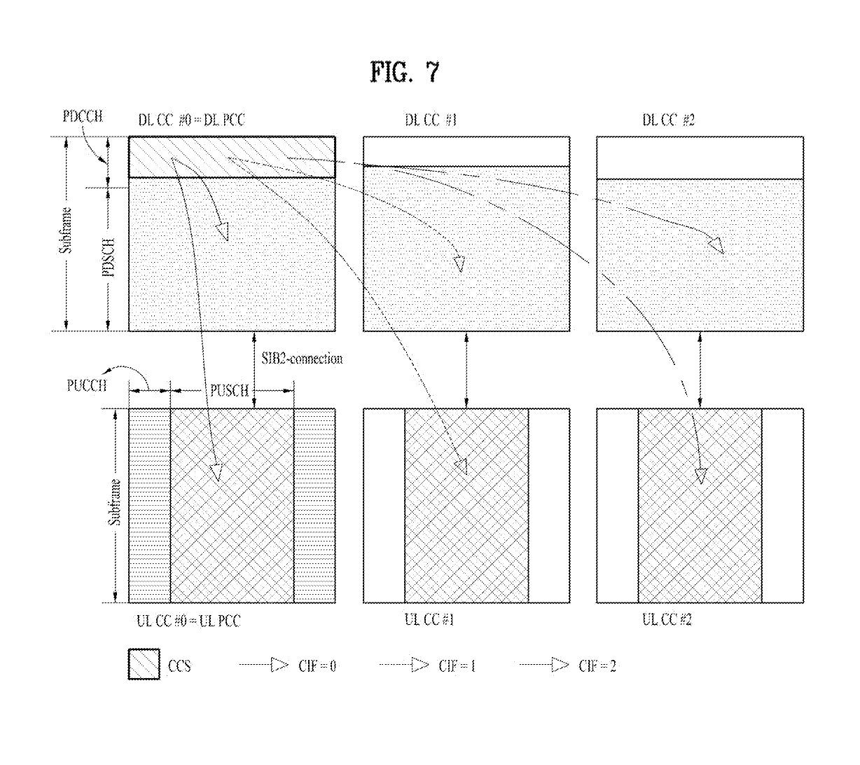

FIG. 7 is a diagram illustrating an application example of a cross carrier scheduling scheme. In particular, in FIG. 8, the number of cells (or component carriers) allocated to the user equipment is three, and the cross carrier scheduling scheme is performed using CIF as described above. In this case, it is assumed that a downlink cell (or component carrier) #A is a primary downlink component carrier (i.e., primary cell (PCell)) and the other component carriers #B and C are secondary component carriers (i.e., secondary cell (SCell)).

In the meantime, it is expected that a long term evolution-advanced (LTE-A) system, which is the standard of the next generation wireless communication system, will support a coordinated multi point (CoMP) transmission scheme, which has not been supported by the existing standard, so as to improve a data transmission rate. In this case, the CoMP transmission scheme means that two or more base stations or cells perform communication with a user equipment located in a shaded zone by coordinating with each other to improve communication throughput between the base station (cell or sector) and the user equipment.

Examples of the CoMP transmission scheme may include a coordinated MIMO type joint processing (CoMP-JP) scheme through data sharing and a CoMP-coordinated scheduling/beamforming (CoMP-CS/CB) scheme.

In case of a downlink according to the joint processing (CoMP-JP) scheme, the user equipment may simultaneously receive data from each base station that performs the CoMP transmission scheme, and may improve receiving throughput by combining the signals received from each base station (joint transmission; JT). Also, there may be considered a method (dynamic point selection, DPS) for transmitting data from one of base stations, which perform the CoMP transmission scheme, to the user equipment at a specific time. Unlike this method, according to the coordinated scheduling/beamforming (CoMP-CS/CB) scheme, the user equipment may momentarily receive data from one base station, that is, serving base station, through beamforming.

In case of an uplink, according to the joint processing (CoMP-JP) scheme, the respective base stations may simultaneously receive a PUSCH signal from the user equipment (Joint Reception; JR). Unlike this, according to the coordinated scheduling/beamforming (CoMP-CS/CB) scheme, only one base station receives a PUSCH signal. At this time, cooperative cells (or base stations) determine to use the coordinated scheduling/beamforming scheme.

In the meantime, the CoMP scheme may be applied to heterogeneous networks as well as a homogeneous network that includes a macro eNB only.

FIG. 8 is a diagram illustrating a configuration of a heterogeneous network to which CoMP scheme may be applied. In particular, FIG. 8 illustrates a network that includes a macro eNB 801 and a radio remote head 802, which transmits and receives a signal at a relatively low transmission power. In this case, a pico eNB or RRH located within coverage of the macro eNB may be connected with the macro eNB through an optical cable. Also, the RRH may be referred to as a micro eNB.

Referring to FIG. 8, since a transmission power of the micro eNB such as RRH is relatively lower than that of the macro eNB, it is noted that coverage of each RRH is relatively smaller than that of the macro eNB.

The aforementioned CoMP scenario is intended to cover a coverage hole of a specific zone through RRHs added as compared with the system in which the existing macro eNB only exists, or is intended that whole system throughput is increased through cooperative transmission by using a plurality of transmission points (TPs) that include the RRH and the macro eNB.

In the meantime, in FIG. 8, RRHs may be divided into two types, wherein one type of the RRHs corresponds to a case where cell ID different from that of the macro eNB is given to each RRH and each RRH may be regarded as another micro cell, and the other type of the RRHs corresponds to a case where each RRH is operated with the same cell ID as that of the macro eNB.

If each RRH is given cell ID different from that of the macro eNB, each of the RRHs and the macro eNB is recognized by the user equipment as an independent cell. At this time, the user equipment located at the edge of the respective cells is seriously affected by interferes of a neighboring cell. Various CoMP schemes have been suggested to reduce such interference and increase a transmission rate.

Next, if each RRH is given the same cell ID as that of the macro eNB, each RRH and the macro eNB are recognized by the user equipment as one cell as described above. The user equipment receives data from each RRH and the macro eNB, and in case of a data channel, precoding used for data transmission of each user equipment may simultaneously be applied to a reference signal, whereby each user equipment may estimate its actual channel to which data are transmitted. In this case, the reference signal to which precoding is applied is the aforementioned DM-RS.

The present invention suggests a problem occurring in the system and its solutions in a state that transmission should be performed at different transmission timings (that is, different timing advances (TAs)) due to the difference in a distance between two reception points (RPs) if an uplink CoMP scheme is used. In this case, the difference in propagation delay may occur due to the difference in a distance between two reception points. Accordingly, different TAs should be used. This is because that TA values are determined on the basis of propagation delay.

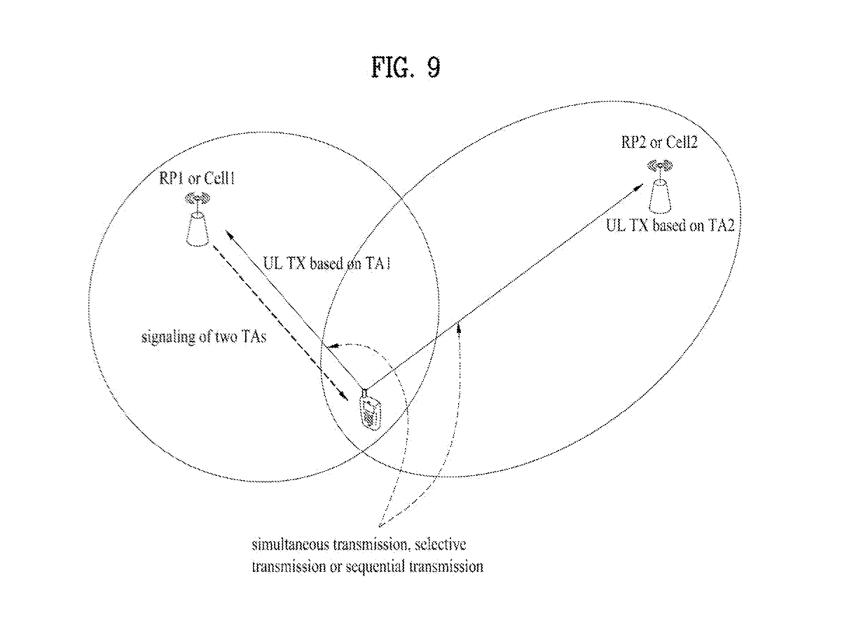

FIG. 9 is a diagram illustrating a wireless communication system to which an uplink CoMP scheme according to the present invention is applied. Particularly, in FIG. 9, it is assumed that a reception point 1 exist at a shorter distance and a reception point 2 exists at a longer distance, and the uplink CoMP scheme is performed between these reception points.

In particular, if a CoMP coordinated beam-forming (CB) scheme is performed, it is assumed that reception is targeted at one of the two reception points at one time. In other words, it is assumed that the user equipment performs transmission towards the reception point 1 for a subframe #n and performs transmission towards the reception point 2 for a subframe #n+1.

In order to support the system as shown in FIG. 9, it is required to signal TAs of different values. TAs of different values may be signaled through RRC signaling in addition to signaling of the existing TA value, and only a difference value of TAs may be notified.

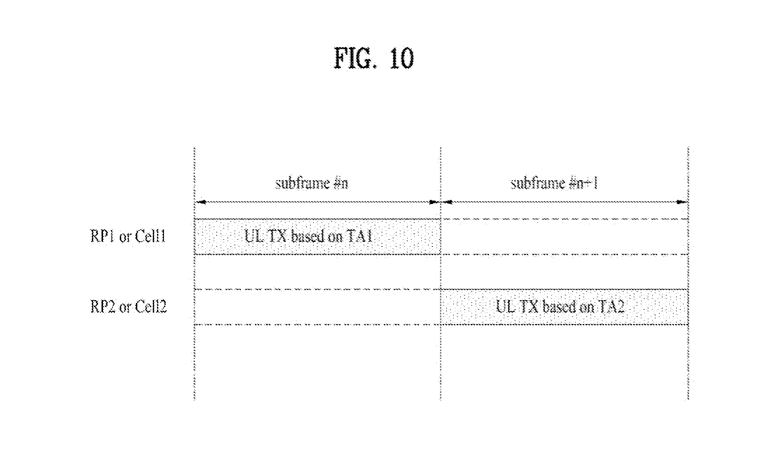

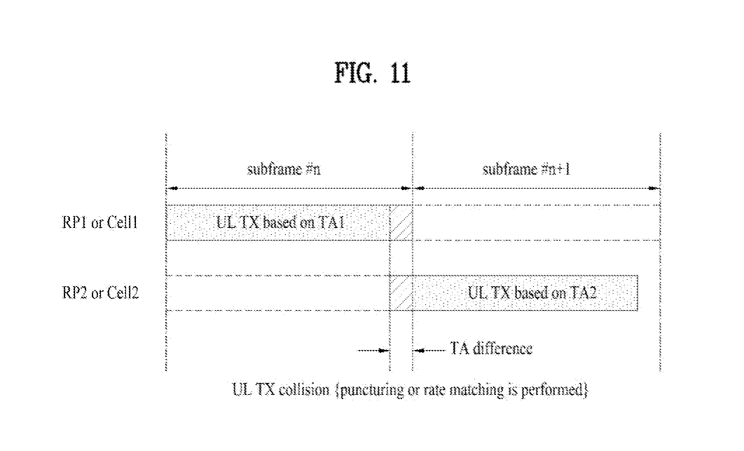

FIGS. 10 and 11 are diagrams illustrating an example of timing advance varied by the difference in a distance between two reception points.

First of all, FIG. 10 illustrates that transmission is performed with the same TA as there is no difference in the distance between two reception points. In this case, it is noted that uplink transmission targeted for reception at the reception point 1 is performed for the subframe #n and uplink transmission targeted for reception at the reception point 2 is performed for the subframe n+1 as soon as the subframe #n ends.

However, if UL transmission should be performed with different uplink transmission timings as propagation delays to two reception points are different from each other as shown in FIG. 11, a problem may occur. In FIG. 11, it is noted that UL transmission targeted for the reception point 2 initiates transmission earlier as much as TA difference value than UL transmission targeted for the reception point 1. For this reason, a problem occurs in that a rear part of the subframe #n is overlapped with a front part of the subframe #n+1.

In order to solve the problem, information as to whether an overlapped part occurs due to the TA difference value or information that may predict occurrence of the overlapped part may preferably be notified to the user equipment, whereby the user equipment may perform rate matching or puncturing for the overlapped part. In this case, one of a method of rate matching for last N₁ number of symbols of the subframe #n and a method of rate matching for first N₂ number of symbols of the subframe #n+1 may be considered. Also, information as to whether an overlapped part occurs due to the TA difference value or information that may predict occurrence of the overlapped part may preferably be received by the user equipment from the serving base station.

In particular, if rate matching should be performed for the last symbol for the subframe #n, it is preferable to design the system by considering that the corresponding sounding reference signal is transmitted to the symbol. This is because that it is defined that the sounding reference signal is transmitted from the last symbol of the subframe on the uplink of the LTE system.

In other words, the user equipment may determine the TA difference value, whereby the user equipment may not perform transmission of SRS existing at the last symbol of the subframe #n, for example, may perform dropping or delaying. Of course, since the eNB may sufficiently predict that the user equipment will perform this operation, there is no problem in the reception operation.

Although rate matching may be performed in case of the PUSCH, it is not preferable to perform rate matching in case of the PUCCH because orthogonality between channels should be maintained. Accordingly, it is required to define a shortened PUCCH format of which PUCCH size is reduced. For example, the shortened PUCCH format dedicated for the first slot, should be used, in which the shortened PUCCH format is designed considering that the PUCCH is not transmitted to the first symbol if the first symbol is overlapped.

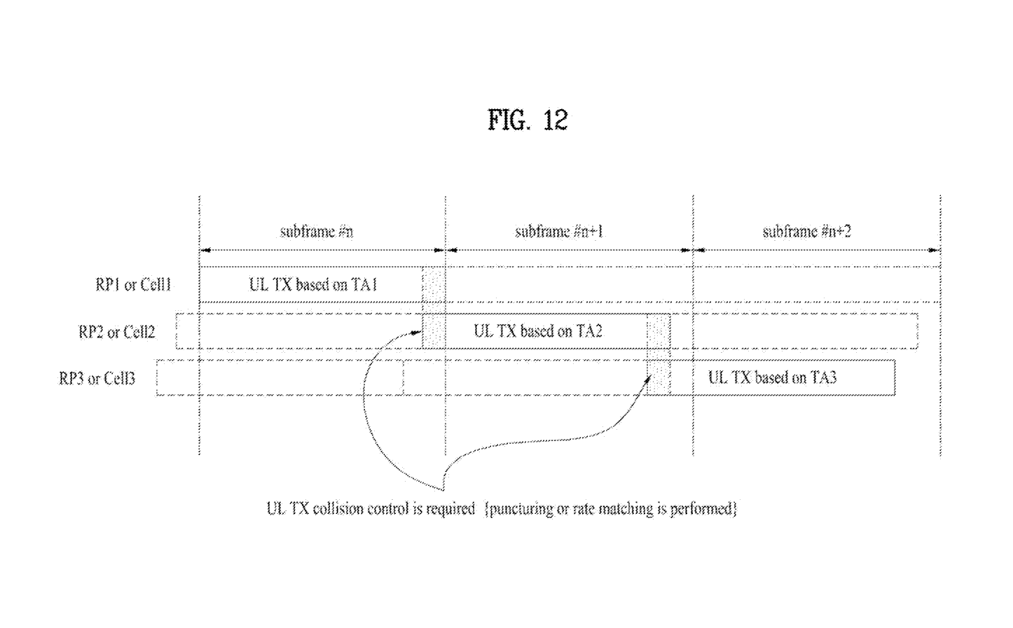

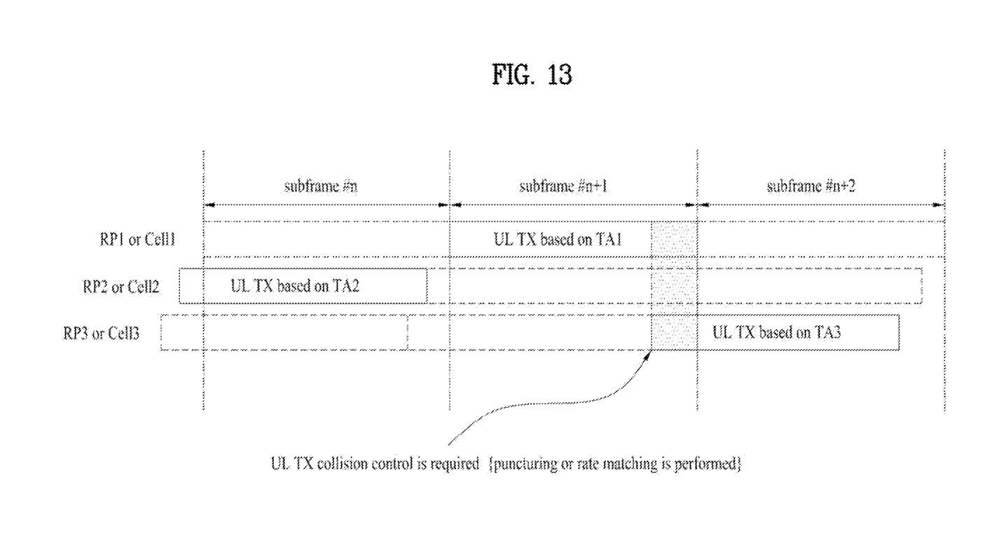

FIGS. 12 and 13 are diagrams illustrating an example of timing advance varied by the difference in a distance among three reception points when CoMP uplink transmission is performed for the three reception points.

In the present invention, it is assumed in FIGS. 12 and 13 that the eNB transfers related information to allow the user equipment to identify the corresponding status. Preferably, an example of the related information includes information indicating a TA value to be set per reception point or indicating how to configure each uplink subframe (for example, information indicating how many symbols are required for rate matching).

Referring to FIG. 12, In case of PUSCH towards the reception point 2, rate matching or puncturing may be performed for an overlapped symbol of PUSCH towards the reception point 1, whereby collision may be avoided. In case of PUSCH towards the reception point 3, rate matching or puncturing may be performed for an overlapped symbol of the PUSCH towards the reception point 2, whereby the corresponding PUSCH may be protected.

FIG. 13 illustrates that the PUSCH towards the reception point 1 is overlapped with the PUSCH towards the reception point 3. In this case, rate matching or puncturing may be performed for the overlapped symbols for the subframe towards the reception point 1, whereby collision may be avoided. Although the above example illustrates that rate matching or puncturing is performed for the rear part of the PUSCH if one or more symbols are overlapped, rate matching or puncturing may be performed for the front part of the PUSCH.

Also, in case of PUCCH collision, puncturing may be performed for the collided symbol as described above or a shortened PUCCH format newly designed to be suitable for a length except for the collided part may be used. In this case, a type of the shortened PUCCH format (for example, shortened PUCCH format dedicated for the first slot) may be determined depending on the location of the collided part, that is, the number of overlapped symbols. In particular, rate matching or puncturing for an uplink signal transmitted to a corresponding reception point or the shortened PUCCH format to be applied may be required to be defined in advance, or a method for configuration through higher layer signaling may be considered.

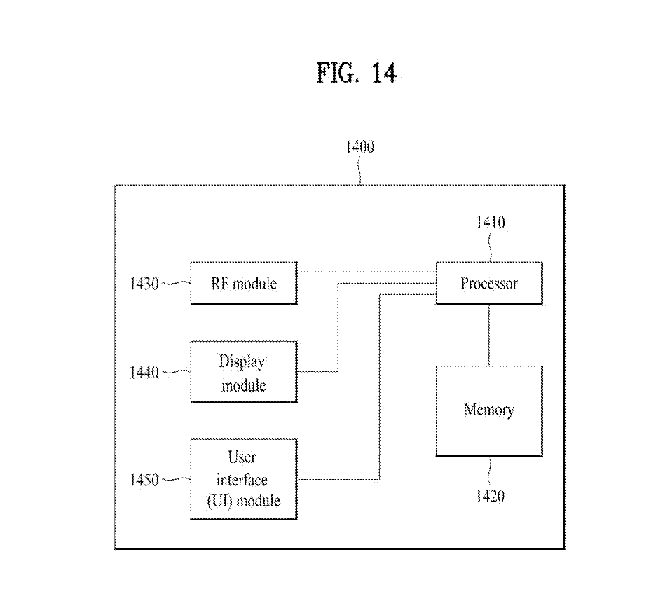

FIG. 14 is a block diagram illustrating a communication apparatus according to one embodiment of the present invention.

Referring to FIG. 14, the communication apparatus 1400 includes a processor 1410, a memory 1420, a radio frequency (RF) module 1430, a display module 1440, and a user interface module 1450.

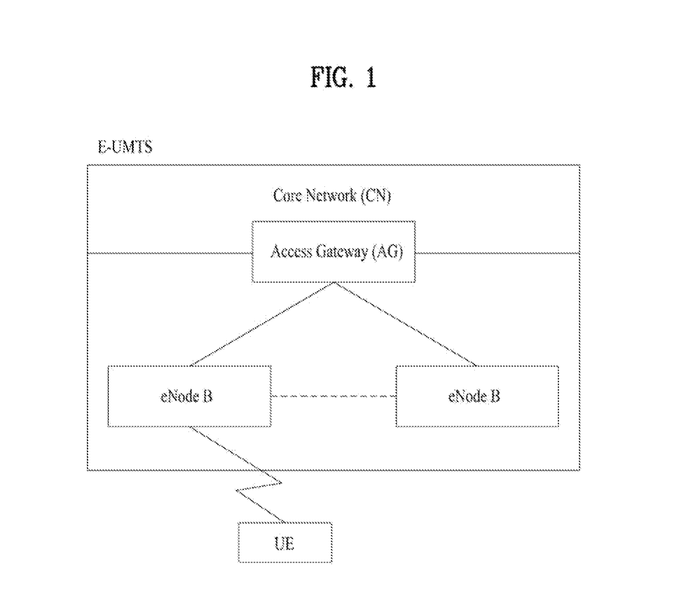

The communication apparatus 1400 is illustrated for convenience of description, and some of its modules may be omitted. Also, the communication apparatus 1400 may further include necessary modules. Moreover, some modules of the communication apparatus 1400 may be divided into segmented modules. The processor 1410 is configured to perform the operation according to the embodiment of the present invention illustrated with reference to the drawings. In more detail, a detailed operation of the processor 1410 will be understood with reference to the disclosure described with reference to FIG. 1 to FIG. 13.

The memory 1420 is connected with the processor 1410 and stores an operating system, an application, a program code, and data therein. The RF module 1430 is connected with the processor 1410 and converts a baseband signal to a radio signal or vice versa. To this end, the RF module 1430 performs analog conversion, amplification, filtering and frequency uplink conversion, or their reverse processes. The display module 1440 is connected with the processor 1410 and displays various kinds of information. Examples of the display module 1440 include, but not limited to, a liquid crystal display (LCD), a light emitting diode (LED), and an organic light emitting diode (OLED). The user interface module 1450 is connected with the processor 1410, and may be configured by combination of well known user interfaces such as keypad and touch screen.

The aforementioned embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

The embodiments of the present invention have been described based on the data transmission and reception between the relay node and the base station. A specific operation which has been described as being performed by the base station may be performed by an upper node of the base station as the case may be. In other words, it will be apparent that various operations performed for communication with the user equipment in the network which includes a plurality of network nodes along with the base station can be performed by the base station or network nodes other than the base station. The base station may be replaced with terms such as a fixed station, Node B, eNode B (eNB), and access point.

The embodiments according to the present invention may be implemented by various means, for example, hardware, firmware, software, or their combination. If the embodiment according to the present invention is implemented by hardware, the embodiment of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiment according to the present invention is implemented by firmware or software, the embodiment of the present invention may be implemented by a type of a module, a procedure, or a function, which performs functions or operations described as above. A software code may be stored in a memory unit and then may be driven by a processor. The memory unit may be located inside or outside the processor to transmit and receive data to and from the processor through various means which are well known.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

Although the aforementioned method for adjusting uplink transmission timing in a base station cooperative wireless communication system and the apparatus for the same have been described based on the 3GPP LTE system, they may be applied to various wireless communication systems in addition to the 3GPP LTE system.

1. A method for transmitting an uplink signal to a plurality of base stations at a user equipment in a wireless communication system, the method comprising the steps of:
receiving, from a serving base station, uplink timing information corresponding to each of the plurality of base stations; and
transmitting the uplink signal to each of the plurality of base stations in a unit of subframe according to the uplink timing information,
wherein, if a transmission timing of a first subframe to a first base station of the plurality of base stations is overlapped with a transmission timing of a second subframe to a second base station that follows the first subframe, at least one symbol of the first subframe overlapping with the second subframe is not transmitted.

2. The method according to claim 1, wherein rate matching or puncturing is performed for the other symbols except for the at least one symbol of the first subframe if the uplink signal transmitted to the first base station is a data signal.

3. The method according to claim 1, wherein a control signal is generated as an uplink control information format having a size of the other symbols except for the at least one symbol in the first subframe if the uplink signal transmitted to the first base station is the control signal.

4. The method according to claim 1, wherein transmitting the uplink signal comprises transmitting the uplink signal prior to a reference timing according to the uplink timing information.

5. The method according to claim 1, wherein the uplink timing information is changed due to the difference of a distance between the user equipment and each of the plurality of base stations.

6. The method according to claim 1, wherein a sounding reference signal scheduled to be transmitted in the first subframe is delayed to one of subframes after the first subframe.

7. The method according to claim 1, wherein a sounding reference signal scheduled to be transmitted in the first subframe is dropped.

8. A user equipment in a wireless communication system, the user equipment comprising:
a wireless communication module configured to communicate a signal with a plurality of base stations; and
a processor configured to process the signal,
wherein the wireless communication module receives uplink timing information corresponding to each of the plurality of base stations from a serving base station,
wherein the processor controls the wireless communication module to transmit an uplink signal to each of the plurality of base stations in a unit of subframe according to the uplink timing information, and
wherein, if a transmission timing of a first subframe to a first base station of the plurality of base stations is overlapped with a transmission timing of a second subframe to a second base station that follows the first subframe, the processor controls the wireless communication module not to transmit at least one symbol of the first subframe overlapping with the second subframe.

9. The user equipment according to claim 8, wherein the processor performs rate matching or puncturing for the other symbols except for the at least one symbol included in the first subframe if the uplink signal transmitted to the first base station is a data signal.

10. The user equipment according to claim 8, wherein the processor generates a control signal as an uplink control information format having a size of the other symbols except for the at least one symbol in the first subframe if the uplink signal transmitted to the first base station is the control signal.

11. The user equipment according to claim 8, wherein the processor controls the wireless communication module to transmit the uplink signal prior to a reference timing according to the uplink timing information.

12. The user equipment according to claim 8, wherein the uplink timing information is changed due to the difference of a distance between the user equipment and each of the plurality of base stations.

13. The user equipment according to claim 8, wherein the processor controls the wireless communication module to delay a sounding reference signal scheduled to be transmitted in the first subframe to one of subframes after the first subframe.

14. The user equipment according to claim 8, wherein the processor drops a sounding reference signal scheduled to be transmitted in the first subframe.
